(19) United States
(12) Patent Application Publication
(10) Pub. No.: US 2011/0261197 A1
(43) Pub. Date: Oct. 27, 2011

(54) METHOD FOR PROVIDING INFORMATION OF A TRAFFIC SIGN AND CAR

(75) Inventors: Oliver WAGNER, Gross Gerau (DE); Ingobert LASSRICH, Trebur (DE); Ali KHANAFER, Mainz (DE); Oliver SCHEPP, Idstein (DE)

(73) Assignee: GM GLOBAL TECHNOLOGY OPERATIONS LLC, Detroit, MI (US)

(21) Appl. No.: 13/073,122

(22) Filed: Mar. 28, 2011

(30) Foreign Application Priority Data
Mar. 30, 2010 (DE) 102010013380.9

(51) Int. Cl. H04N 7/18

(52) U.S. Cl. 348/148; 348/E07.088

(57) ABSTRACT

A method is provided for the provision of information of a traffic sign. The method includes, but is not limited to sensing of a traffic sign by means of a determination device of a first vehicle takes place. The determination device includes, but is not limited to at least one optical camera. In addition, determination of information of the traffic sign by means of the determination device takes place. In addition, transmission of the determined information of the traffic sign to at least one second vehicle takes place.

### CROSS-REFERENCE TO RELATED APPLICATION

This application claims priority to German Patent Application No. 102010013380.9, filed Mar. 30, 2010, which is incorporated herein by reference in its entirety.

### TECHNICAL FIELD

The application relates to a method for the provision of information of a traffic sign, a vehicle with a determination device and a transmission device, a computer program and a machine-readable medium.

### BACKGROUND

From DE 10 2008 061 304 A1 a transmission of vehicle-relevant data of a vehicle via mobile communication is known. An example relates to vehicles with a radio key which makes it possible to open the vehicle by means of radio. This communication technique is used to make available the information of dynamic traffic signs to passing vehicles. To this end, the dynamic traffic signs are equipped with senders.

At least one object of the application is to state a method for the provision of information of a traffic sign, a vehicle, a computer program and a machine-readable medium, which allow better consideration of traffic signs, particularly road signs, in a simple and cost-effective manner. In addition, other objects, desirable features and characteristics will become apparent from the subsequent summary and detailed description, and the appended claims, taken in conjunction with the accompanying drawings and this background.

### SUMMARY

A method for the provision of information of a traffic sign is stated, wherein the method comprises the following steps. Sensing of a traffic sign by means of a determination device of a first vehicle takes place, wherein the determination device comprises at least one optical camera. In addition, a determination of information of the traffic sign by means of the determination device takes place. In addition, a transmitting of the determined information of the traffic sign to at least a second vehicle takes place.

The method according to the application makes possible in advantageous manner an improved consideration of traffic signs, particularly road signs by road users. In addition, the method according to the application is particularly simple and cost-effective since the necessity of equipping traffic signs with senders is omitted. There, the application starts out from the idea that vehicles to an increasing degree are equipped with optical cameras and transmission devices for transmitting information to further vehicles, as a result of which the method according to the application in an advantageous manner can make use of components already existing in the first vehicle.

The determined information preferably includes a type of the traffic sign. In addition, the determined information preferably contains information depicted on the traffic sign. Besides, the depicted information can contain a value of a speed restriction.

The determined information of the traffic sign is transmitted to the at least one second vehicle in a preferred embodiment by means of a vehicle-to-vehicle communication device.

In a further embodiment of the method a distance of the first vehicle to vehicles present in the vicinity of the first vehicle is determined and the determined information of the traffic sign transmitted to those vehicles whose distance to the first vehicle is below a predetermined threshold value. This embodiment has the advantage that the determined information can be specifically transmitted to those vehicles for which this information is of particularly high relevance. For example, the information relating to the value of a speed restriction can be transmitted to those vehicles which are present within the range of validity of the speed restriction, if the predetermined threshold value has a comparable quantity.

In a further embodiment the first vehicle comprises a storage device with at least one stored shape and/or at least one stored color of at least one traffic sign and at least one stored piece of information regarding the at least one traffic sign. In this embodiment, the sensing of the traffic sign contains the following steps. Taking of at least one image by means of the at least one optical camera takes place. In addition, searching of a region within the at least one image which contains the at least one stored shape and/or the at least one stored color of the at least one traffic sign. This embodiment thereby starts out from the consideration that traffic signs have a standardized shape and standardized colors as a result of which these are particularly suitable for sensing of the traffic sign.

Besides, the determination of information of the traffic sign can contain a provision of the at least one stored information. For example the at least one stored piece of information can contain the type of the traffic sign, as a result of which a determination of a corresponding information of the traffic sign can take place in a simple manner through the provision of the stored information.

In a preferred embodiment a plurality of images are recorded by means of the at least one optical camera with a recording frequency, wherein the recording frequency is set as a function of the speed of the first vehicle. As a result of this, the sensing of the traffic sign can be adapted to the speed of the first vehicle in an advantageous manner.

The application additionally relates to a vehicle comprising a determination device with at least one optical camera wherein the determination device is designed for the sensing of a traffic sign and for determining information of the traffic sign. In addition, the vehicle comprises a transmission device which is designed for transmitting the determined information of the traffic sign to at least one second vehicle.

According to the application, the vehicle has the advantages already mentioned in connection with the method according to the application, which at this point are not mentioned again to avoid repetitions.

The transmission device preferably comprises a vehicle-to-vehicle communication device.

In a further embodiment the vehicle additionally comprises a storage device with at least one stored shape and/or at least one stored color of at least one traffic sign and at least one piece of stored information regarding the at least one traffic sign. Besides, the storage device can be a component part of the determination device.

The vehicle is preferably a motor vehicle, more preferably a passenger car or a commercial vehicle.

In addition, the application relates to a computer program which, if executed on a computation unit of a first vehicle, directs the computation unit to carry out the following steps. The computation unit is prompted for sensing a traffic sign by means of a determination device of the first vehicle, wherein the determination device comprises at least one optical camera. In addition, the computation unit is prompted for the determination of information of the traffic sign by means of the determination device. In addition, the computation unit is prompted for transmitting the determined information of the traffic sign to at least one second vehicle by means of a transmission device of the first vehicle.

The application additionally relates to a machine-readable medium on which a computer program according to the mentioned embodiment is stored.

The computer program and the machine-readable medium have the advantages already mentioned in connection with the method of the application, which at this point are not repeated again to avoid repetitions.

### BRIEF DESCRIPTION OF THE DRAWINGS

The present invention will hereinafter be described in conjunction with the following drawing figures, wherein like numerals denote like elements, and:

FIG. 1 is shows a flow diagram of a method for the provision of information of a traffic sign according to an embodiment;

FIG. 2 is shows an example of a traffic situation in which the method for the provision of information of a traffic sign can be applied; and

FIG. 3 is shows a determination device with at least one optical camera of the first vehicle according to FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

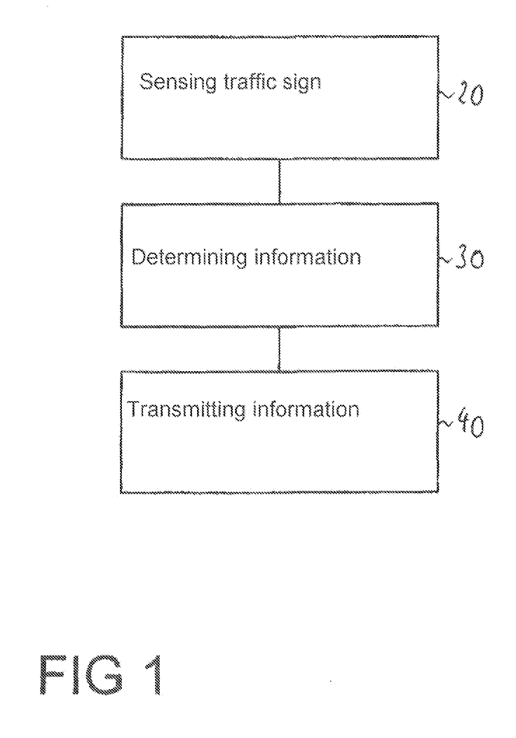

FIG. 1 shows a flow diagram of a method for the provision of information of a traffic sign according to an embodiment.

To this end, a sensing of a traffic sign by means of a determination device of a first vehicle takes place in a step 20, wherein the determination device comprises at least one optical camera. The determination device to this end can comprise a storage device with at least one stored shape and/or at least one stored color of at least one traffic sign and at least one stored piece of information relating to the at least one traffic sign. For sensing the traffic sign a recording of at least one image by means of the at least one optical camera and a searching of a region within the at least one image containing the at least one stored shape and/or the at least one stored color of the at least one traffic sign takes place.

In a step 30 a determination of information of the sensed traffic sign by means of the determination device takes place. The determined information can contain a type of the traffic sign and/or a piece of information depicted on the traffic sign, more preferably a value of a speed restriction.

In a step 40, a transmission of the determined information of the traffic sign to at least one second vehicle takes place. The determined information of the traffic sign is transmitted to the at least one second vehicle preferably by means of a vehicle-to-vehicle communication device.

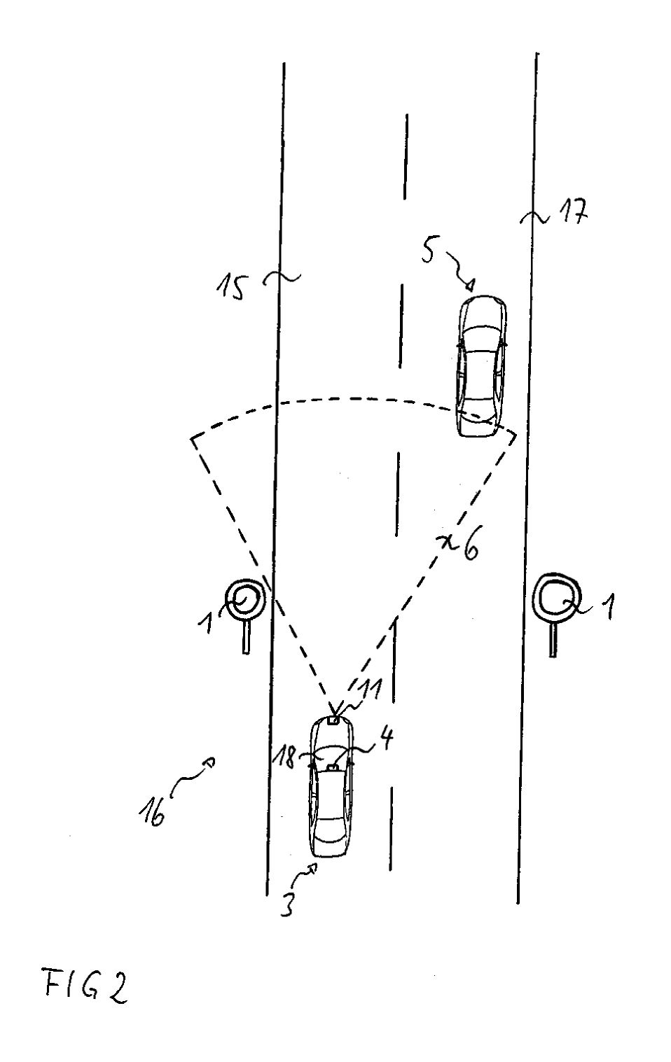

FIG. 2 shows an example of a traffic situation in which the method for the provision of information of a traffic sign, more preferably the method according to FIG. 1, can be applied.

In the shown traffic situation a first vehicle 3 is located on a first lane 15 of a road 16. On a second lane 17 of the road 16, which is located adjacently to the first lane 15, a second vehicle 5 travels in the same driving direction in which the first vehicle 3 is also travelling. In the shown embodiment the first vehicle 3 and the second vehicle 5 are motor vehicles in the form of passenger cars.

The first vehicle 3 comprises an optical camera 4 which is a component part of a determination device of the first vehicle 3 which is not represented in more detail. Besides, in the shown embodiment, the optical camera 4 is arranged in the region of a windshield 18 of the first vehicle 3, for example on a rear-view mirror of the first vehicle 3.

With the help of the optical camera 4 traffic signs 1, which are located in driving direction of the first vehicle 3 within a sensing range of the optical camera 4 which is not shown in more detail can be determined. In addition, information of the traffic sign 1 can be determined with the help of the optical camera 4. In the shown embodiment, the traffic signs 1 are static road signs, i.e. road signs whose information remains the same. In addition to this it is also conceivable that traffic signs containing dynamic information, for example traffic signs of a traffic management control which can adapt a currently applicable speed restriction to the respective traffic situation, particularly a traffic density, are sensed with the help of the optical camera 4 and information of this traffic sign can be likewise determined with the help of the optical camera 4.

The determined information of the traffic sign 1 is transmitted to the second vehicle 5. The second vehicle 5 in the embodiment shown in this case is located in a schematically represented sensing range 6 of a radar sensor 11 of the first vehicle 3 and because of this can be automatically determined by the first vehicle 3. The transmission of transmitted information of the traffic signs 1 to the second vehicle 5 for example takes place by means of a vehicle-to-vehicle communication device which is not shown in more detail, wherein both the first vehicle 3 as well as the second vehicle 5 also has a corresponding communication device. Further details of the determination device are explained in more detail in connection with the following Figure.

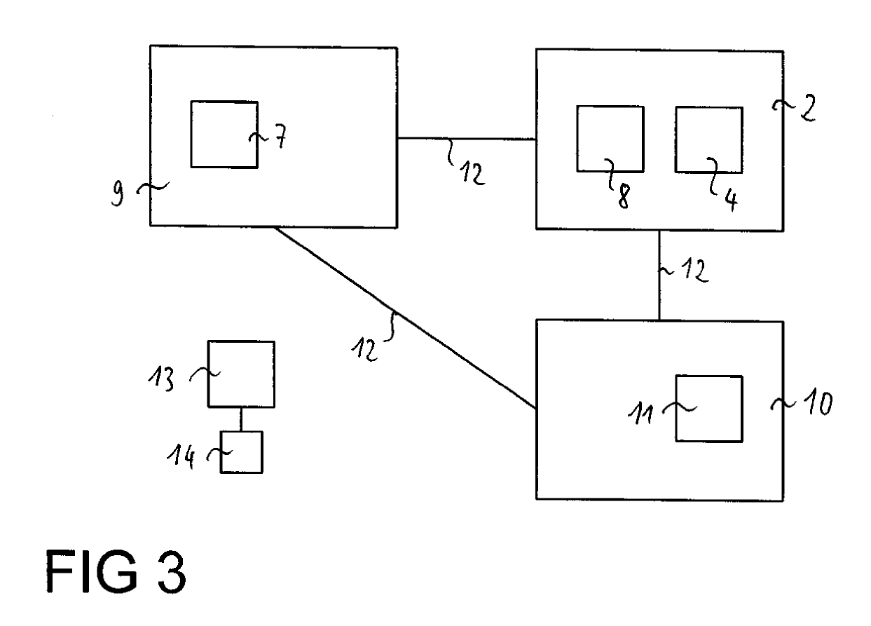

To this end, FIG. 3 shows a determination device 2 of the first vehicle according to FIG. 2. Components with the same functions as in FIG. 2 are marked with the same reference characters and not again discussed in the following.

The first determination device 2 comprises the optical camera 4 and is designed for sensing a traffic sign and for determining information of the traffic sign. To this end, the first determination device 2 in the embodiment shown comprises a storage device 8 with at least one stored shape and/or at least one stored color of at least one traffic sign and at least one stored piece of information regarding the at least one traffic sign.

The first determination device 2 is connected to a second determination device 10 via a connecting line 12. The second determination device 10 contains the radar sensor 11 and can for example be a component part of an ACC-system (adaptive cruise control).

The first determination device 2 and the second determination device 10 are connected to a transmission device 9 of the first vehicle via further connecting lines 12. The transmission device 9 is designed for transmitting the transmitted information of the traffic sign to at least one second vehicle and to this end in the embodiment shown comprises a vehicle-to-vehicle communication device 7.

The connecting lines 12 can at least partially be realized with the help of a CAN-bus of the first vehicle.

In the shown embodiment, the first vehicle additionally comprises a computation unit 13 and a machine-readable medium 14, wherein on the machine-readable medium 14 a computer program is stored, which, when executed on the computation unit 13, prompts the computation unit to carry out the steps mentioned in connection with FIG. 1 by means of the elements mentioned there. To this end, the computation unit 13 is directly or indirectly connected to the first determination device 2, of the second determination device 10 and the transmission device 9 in a manner not shown in more detail.

The application thus makes possible in an advantageous manner a better consideration particularly of road signs, for example speed restrictions by as large as possible a number of road users. To this end, in one embodiment, an optical camera in a vehicle detects a traffic sign and transmits this information to other road users via a vehicle interface, preferably to road users travelling ahead and behind. Because of this, attention of as high as possible a number of road users is drawn to the fact that for example a speed-restricted region has started or that one is within a region with certain traffic rules.

Although at least one exemplary embodiment in the preceding description has been shown, different changes and modifications can be carried out. The mentioned embodiments are merely examples and not intended to restrict the scope of application, the applicability or the configuration in any manner whatsoever. On the contrary, the preceding description makes available to the person skilled in the art with a plan for implementing at least one exemplary embodiment, wherein numerous changes in the function and in the arrangement of elements described in an exemplary embodiment can be made without leaving the scope of protection of the attached Claims and their legal equivalent.

1. A method for provision of information of a traffic sign, comprising:
sensing of the traffic sign with a determination device of a first vehicle, the determination device comprising an optical camera;
determination of information of the traffic sign with the determination device; and
transmitting of the information of the traffic sign to a second vehicle.

2. The method according to claim 1, wherein the information of the traffic sign comprises a traffic sign type.

3. The method according to claim 1, wherein the information of the traffic sign comprises a piece of information depicted on the traffic sign.

4. The method according to claim 3, wherein the piece of information comprises a value of a speed restriction.

5. The method according to claim 1, wherein the transmitting of the information of the traffic sign is performed with vehicle-to-vehicle communication device.

6. The method according to Claim 1, further comprising:
determining a distance of the first vehicle with respect to the second vehicles located in a vicinity of the first vehicle, and wherein the transmitting of the information of the traffic sign comrpises transmitting the information of the traffic sign to the second vehicle if the distance to the first vehicle is below a predetermined threshold value.

7. The method according to claim 1, wherein the first vehicle comprises a storage device configured to store stored traffic sign shape and a stored piece of information regarding the traffic sign and wherein the sensing of the traffic sign comprises:
recording of an image with the optical camera; and
searching of a region within the image that contains the stored traffic sign shape.

8. The method according to claim 7, wherein the determining of the information of the traffic sign comprises provisioning of the stored piece of information.

9. The method according to claim 7, further comprising recording a second image with the optical camera with a recording frequency,
wherein the recording frequency is set as a function of a speed of the first vehicle.

10. A vehicle comprising;
a determination device comprising an optical camera, the determination device configured to:
sense a traffic sign: and
determine information of the traffic sign; and
a transmission device configured to transmit the information of the traffic sign to a second vehicle.

11. The vehicle according to claim 10, wherein the transmission device comprises a vehicle-to-vehicle communication device.

12. The vehicle according to claim 10, further comprising a storage device with a stored shape of at least one traffic sign and a stored piece of information regarding the traffic sign.

13. The vehicle according to claim 12, wherein the storage device is a component part of the determination device.

14. A computer readable medium embodying a computer program product, said computer program product comprising
a program for provision of information of a traffic sign, the program configured to:
sense the traffic sign with a determination device of a first vehicle, the determination device comprises comprising an optical camera;
determine information of the traffic sign with the determination device; and
transmit the information of the traffic sign to second vehicle with a transmission device of the first vehicle.

15. (canceled)

16. The computer readable medium embodying the computer program product according to claim 14, wherein the information of the traffic sign comprises a traffic sign type.

17. The computer readable medium embodying the computer program product according to claim 14, wherein the information of the traffic sign comprises a piece of information depicted on the traffic sign.

18. The computer readable medium embodying the computer program product according to claim 17, wherein the piece of information comprises a value of a speed restriction.

19. The computer readable medium embodying the computer program product according to claim 17, wherein the program is further configured to transmit of the information of the traffic sign with a vehicle-to-vehicle communication device.

20. The computer readable medium embodying the computer program product according to claim 14, the program further configured to:
determine a distance of the first vehicle with respect to the second vehicle located in a vicinity of the first vehicle, and
transmit the information of the traffic sign to the second vehicle if the distance to the first vehicle is below a predetermined threshold value.

21. The computer readable medium embodying the computer program product according to claim 14, wherein the first vehicle comprises a storage device configured to store a stored traffic sign shape and a stored piece of information regarding the traffic sign and wherein the program is further configured to:
record an image with the optical camera; and
search a region within the image that contains the stored traffic sign shape.
